(19) United States
(12) Patent Application Publication
(10) Pub. No.: US 2024/0083329 A1
(43) Pub. Date: Mar. 14, 2024

(54) MULTI-THICKNESS ORE UNLOADING MAT

(71) Applicant: Manuel Alexander MEDEL ECHEVERRÍA, Miami, FL (US)

(72) Inventor: Manuel Alexander MEDEL ECHEVERRÍA, Miami, FL (US)

(21) Appl. No.: 18/451,552

(22) Filed: Aug. 17, 2023

(30) Foreign Application Priority Data
Sep. 1, 2022 (CL) 202202383

(51) Int. Cl. B60P 1/64

(52) U.S. Cl. CPC B60P 1/6409

(57) ABSTRACT

The invention relates to a multi-thickness ore unloading mat, designed to favor the circulation of an ore over said mat, and which presents improved resistance to impact and/or wear. The proposed ore unloading mat presents a body that has different thicknesses distributed in such a way that a thickness gradient is generated, which prevents ore stagnation on the unloading mat and at the same time increases the resistance to impact and/or wear of the body that forms said unloading mat.

### CROSS REFERENCE TO RELATED APPLICATIONS

The present application claims priority of Chile patent application number 202202383 filed Sep. 1, 2022.

### APPLICATION FIELD

The invention relates to a multi-thickness ore unloading mat designed to favor the circulation of an ore over said mat and which presents improved resistance to impact and/or wear. The proposed ore unloading mat presents a body that has different thicknesses distributed in such a way that a thickness gradient is generated, which prevents ore stagnation on the unloading mat and at the same time increases the resistance to impact and/or body wear forming said unloading mat.

The unloading mat of the invention can be used in various applications, for example, to form or cover the walls of a transfer chute or hopper, or to form or cover the floor of a dump truck hopper.

### BACKGROUND OF THE INVENTION

Ore unloading mats are widely used in applications where ore is required to be transported from one place to another, for example, in the mining industry. In this case, the ore is a commonly abrasive raw material that is extracted from an ore deposit and transported to processing. In one or several stages of the process, said raw material is subjected to discharge stages, at which point it passes over an unloading mat that receives the raw material and directs it towards an ore outlet end. For example, the ore that is transported on a conveyor belt is directed towards a transfer chute, wherein one or several unloading mats are arranged in said chute to receive the ore and direct it towards the outlet of the chute or hopper. Another example is the ore that is transported in the hopper of a dump truck, where the floor of said hopper corresponds to the ore unloading mat, acting when the truck is ready to unload the ore by tilting the hopper.

The ore unloading mats during their operation are subjected to great stresses derived from the impact and abrasion of the circulating ore, for which reason they usually suffer breakage and wear because of said stresses. In this context, although the unloading mats are used as a protective and/or absorbent element of said efforts, to avoid damage to mining equipment, for example, there are solutions to reinforce the same mats against specific efforts, such as shearing. Among these solutions are the use of resistant fabrics embedded in the mat, for example, Kevlar, metal meshes or other reinforcement that is integrated into the mat. The implementation of reinforcement elements in the mat not only makes the solution more expensive, but also makes manufacturing the mat substantially more complex.

There are several solutions associated with ore unloading mats aimed at solving the main problems associated with unloading operations. For example, document U.S. Pat. No. 8,021,738B2 defines a wear and impact resistant lining comprising a rubber matrix on a flat steel plate including spaced steel strips to prevent shearing of the rubber matrix during operation. This solution makes it possible to increase the resistance of the coating by incorporating metal bars that are embedded in the rubber matrix, which not only makes the coating more expensive, but also makes it more complex to manufacture. Indeed, when coating mining equipment with the solution described in document U.S. Pat. No. 8,021,738B2, a surface coated with a uniform coating is obtained, in which specific areas of the equipment that are subjected to greater impact and/or abrasion stress are not considered.

On the other hand, publication WO2020200400A1 describes another type of wear lining made up of multiple small-sized ceramic units which are joined by a rubber substrate. In this case, a coating whose geometry is easily adaptable to the surface to be coated is sought, which is achieved by the small ceramic units and the ease of separating them by cutting the rubber substrate. In this case, the coating solution generates multiple gaps between ceramic units that favor ore stagnation and, with it, ore accumulation on the coating, reducing its useful surface. In addition, the solution of multiple lining units joined together favors the detachment and/or wear of isolated lining units, mainly in the areas that are subjected to greater impact and/or abrasion stress.

Another example corresponds to the solution described in document AU2012327208B2, corresponding to a truck hopper whose floor is a rubber mat suspended on ropes. In this case, the rubber mat is presented as a single body, solving the problems derived from coatings or mats formed by multiple coating units joined together. In addition, the mat described in document AU2012327208B2 has a thickened section at its rear end, a section that occupies approximately one third of the length of the mat increasing resistance to particularly strong impacts and wear at said end. Indeed, the rear end of the mat which corresponds to the output end of the material from the hopper, is subjected to greater stress than the rest of the mat. Said efforts are given by the contact of the mat with external elements during unloading as a result of its proximity to ground level when the hopper is raised, as it corresponds to the area of the mat that presents the greatest circulation of material during unloading presenting a higher material flow density than the rest of the mat.

In view of the foregoing, although the solution described in document AU2012327208B2 makes it possible to increase the useful life of the mat by improving its resistance in areas subjected to greater stress, it generates other problems derived from the change in thickness of the mat. Said problems are due to the fact that the greater thickness of the output end of the mat described in document AU2012327208B2 acts as a stop for the material that circulates from the zone of less thickness, generating an area of ore accumulation as shown in FIG. 1 On the other hand, the change in thickness in the mat generates a zone of stress concentration, which after several cycles of operation results in localized failure of the mat, as shown in FIGS. 2a and 2b.

Consequently, the ore unloading mat of the present invention seeks to solve the aforementioned problems providing a one-piece unloading mat, resistant to wear and impact caused by the ore, reinforced at its outlet end, and that prevents the stagnation of ore during its unloading.

### DETAILED DESCRIPTION OF THE INVENTION

In its general aspects, the invention relates to an ore unloading mat which favors the movement of ore on an inclined plane towards an outlet end of said unloading mat. To do this, the proposed ore unloading mat presents a thickness variation in its longitudinal direction, generating a thickness gradient that facilitates the movement of ore over the mat.

Consequently, one of the main objectives of the invention is to provide an unloading mat which arranged in an inclined manner, favors the circulation of an ore on it, avoiding the stagnation of the ore in one or several areas of said unloading mat and thereby avoiding ore accumulation as shown in FIG. 1.

A specific objective of the invention is to provide an unloading mat that together with preventing ore stagnation, increases the resistance to impact and/or wear of the mat, specially at its outlet end seeking to avoid the formation of stress concentrations resulting in localized mat failure, as shown in FIGS. 2a and 2b.

Another specific objective of the invention is to provide at least one unloading mat for a transfer chute or hopper which prevents ore stagnation inside the chute and improves the resistance to impact and/or wear of said chute. In this case, the unloading mat can be presented as a coating that is arranged on one or more structural walls of the chute.

Another specific objective of the invention is to provide at least one unloading mat for a dump truck hopper which prevents ore stagnation inside the hopper and improves the resistance to impact and/or wear of the floor of said hopper. In this case, the unloading mat can be presented as a coating that is arranged on the floor of the hopper or forming the same floor of the hopper, for example, by means of a hanging or suspended ore unloading mat.

In order to meet said objectives, the invention proposes an ore unloading mat formed by a rubber body having a length and a width, wherein said rubber body comprises an upper face or working face and an outlet end. The working face corresponds to the area of the rubber body that is in contact with an ore, at least during the movement of said ore over the rubber body. The outlet end corresponds to an edge of the rubber body where the circulating ore is no longer in contact with the working face, heading out of the unloading mat. The rubber body has a thickness gradient that increases towards the outlet end, wherein said thickness gradient is formed by three or more thicknesses distributed in the ore flow direction which usually corresponds to the length of the rubber body.

According to one embodiment of the invention, the rubber body of the ore unloading mat is provided in the form of a liner wherein the rubber body is attached to a structural surface supporting the unloading mat.

According to another embodiment of the invention, the rubber body of the ore unloading mat is arranged to form the floor of a dump truck hopper arranged hanging or suspended on a structural frame that forms the hopper.

According to the second embodiment of the invention, the rubber body can be fixed to the structural frame by connecting two or more edges of the rubber body with said structural frame, leaving free the edge corresponding to the output end of said body. In addition, the rubber body may comprise a lower face or support face opposite to the working face wherein said support face may be connected to the structural frame by means of a set of ropes or support bands which have two ends that are fixed releasably to the structural frame that forms the hopper.

According to the second embodiment of the invention, the ropes or support bands can be formed by a core wrapped in neoprene, a material that contacts the support face of the mat to hold it in a suspended manner. In addition, the ends of the ropes or bands may be formed of an alloy of materials to improve the strength of the rope or band, said alloy of materials may include Kevlar, another high-strength fiber-reinforced composite material or other material of similar mechanical behavior. In this case, the ends of each rope or band can form an opening that is connected to the structural frame by means of a fixing and tensioning device.

The invention also aims to define specific applications of the unloading mat, such as its implementation in a transfer chute or in the hopper of a dump truck.

### BRIEF DESCRIPTION OF THE FIGURES

As part of the present invention, the following representative Figures thereof are presented which show preferred embodiments of the invention and, therefore, should not be considered as limiting the definition of the claimed subject matter.

FIG. 1: It exemplifies the problem of material stagnation on an unloading mat causing the accumulation of material on said mat.

FIGS. 2a and 2b: They exemplify the localized failure problem of the unloading mat towards its output end.

FIG. 3: Shows a perspective view of a first embodiment of the rubber body of the invention.

FIG. 4: Shows a perspective view of a second embodiment of the rubber body of the invention.

FIG. 5: Shows a side view of an embodiment of the rubber body of the invention.

FIG. 6: Shows an embodiment of the invention with an unloading mat that is part of a transfer chute.

FIG. 7: Shows an embodiment of the invention with an unloading mat that is part of a dump truck hopper.

FIG. 8: Shows an example of a dump truck hopper without the unloading mat.

### DESCRIPTION OF THE PREFERRED EMBODIMENTS

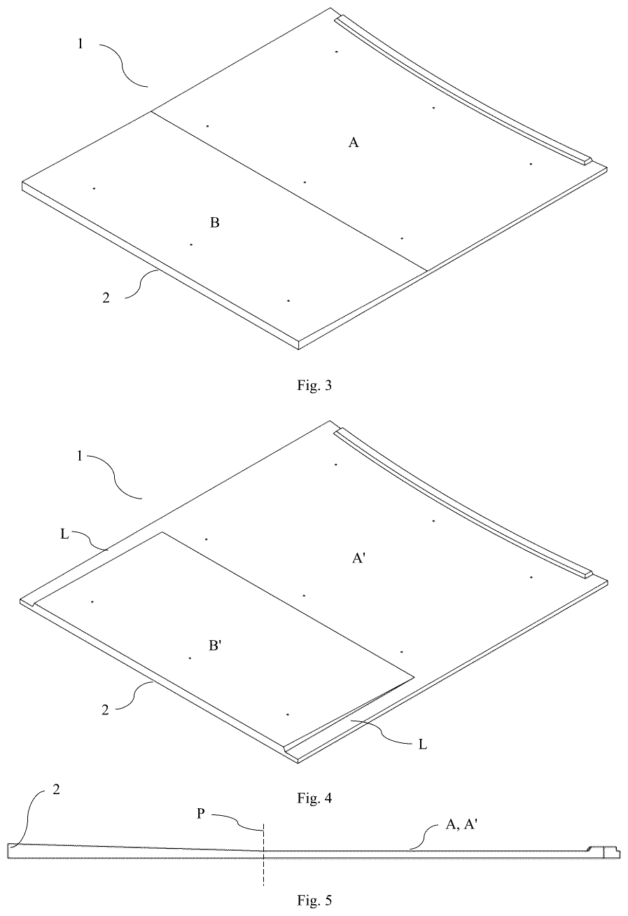

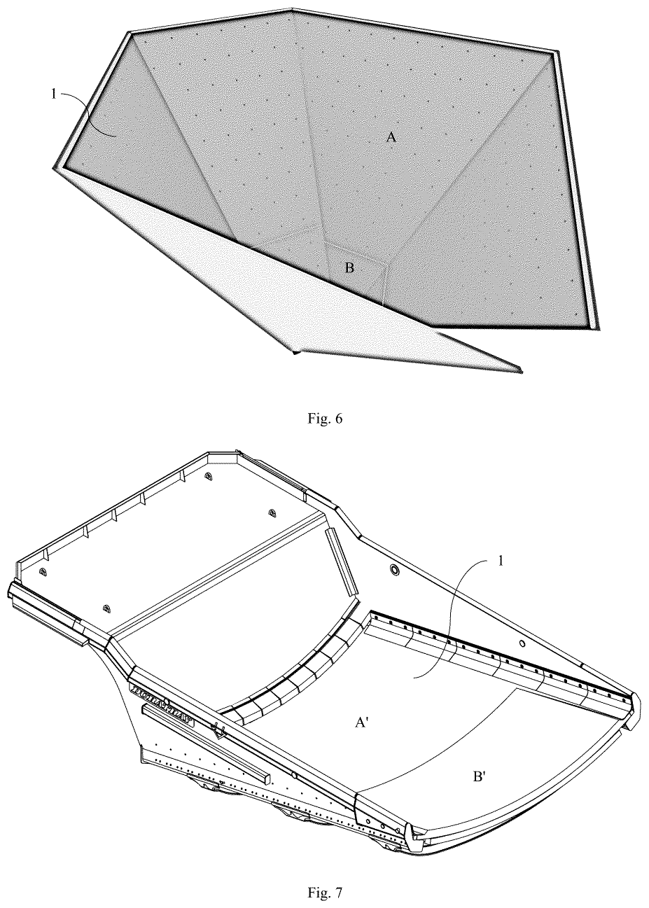

In FIG. 3 a perspective view of a first embodiment of the rubber body (1) of the unloading mat of the invention is shown. In said embodiment, it is possible to appreciate that the rubber body has at least two portions, a first portion (A) characterized in that it has a substantially uniform thickness and a second portion (B) characterized in that it has a variable thickness. In the second portion (B) of the rubber body (1) the thickness variation is such that it increases from the first portion (A) towards the outlet end (2). Said variation of thickness is characterized in that it generates a thickness gradient that has at least three different thicknesses, preferably one that presents a continuous variation in the thickness of the rubber body (1), as can be seen in FIG. 5.

In FIG. 4 a second embodiment of the rubber body (1) is shown. In said embodiment, it is possible to appreciate that the rubber body also has at least two portions, a first portion (A′) characterized in that it has a substantially uniform thickness and a second portion (B′), characterized in that it has a variable thickness. Unlike the first embodiment of FIG. 3, the embodiment shown in FIG. 4 teaches that the second portion (B′) may be surrounded on its sides by the first portion (A′), forming a lateral edge (L) which maintains a substantially uniform thickness with the thickness of the first portion (A′).

As previously mentioned, FIG. 5 shows a side view of the rubber body (1) wherein it is possible to appreciate the formation of the thickness gradient which begins with a thickness equivalent to that of the first portion (A, A′) of uniform thickness and ends with a greater thickness corresponding to that of the output end (2). In FIG. 5, an imaginary line (P) is shown denoting the change between the substantially uniform thickness portion and the portion with the thickness gradient. It is important to note that by substantially uniform thickness it must be understood a thickness whose average value in different sections does not vary in the same terms as the thickness gradient of the second portion of the rubber body. The substantially uniform thickness portion may have thickness variations given by the margin of error of each manufacturing procedure.

FIG. 6 shows an application example of a first embodiment of the invention wherein the rubber body (1) of the unloading mat is arranged covering the structural walls of a transfer chute. In this application, the rubber body (1) is arranged with its outlet end towards the outlet of the chute, that is, where the material or ore entering the chute exits. This means that the thickness gradient increases towards the outlet of the chute, avoiding the occurrence of jams that may occur at the outlet of the chute and improving the wear resistance of the rubber mat at said outlet of the chute. It is important to note that the chute outlet corresponds to one of the chute areas where the circulating material has a higher percentage of contact with the chute walls, therefore it corresponds to the area with the greatest abrasion wear.

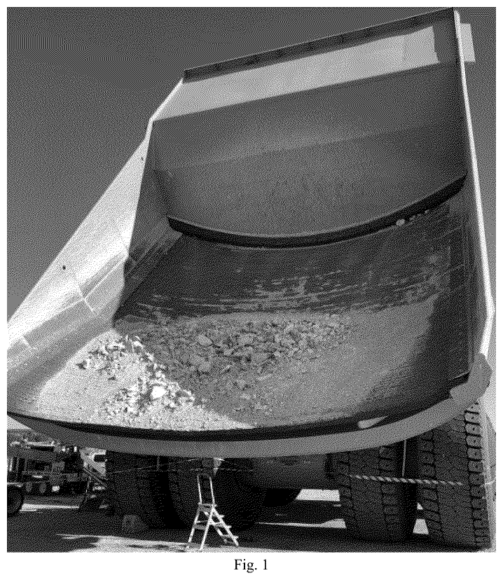

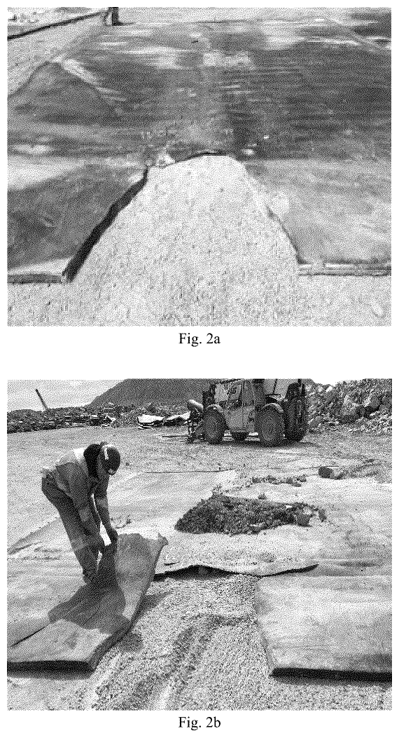

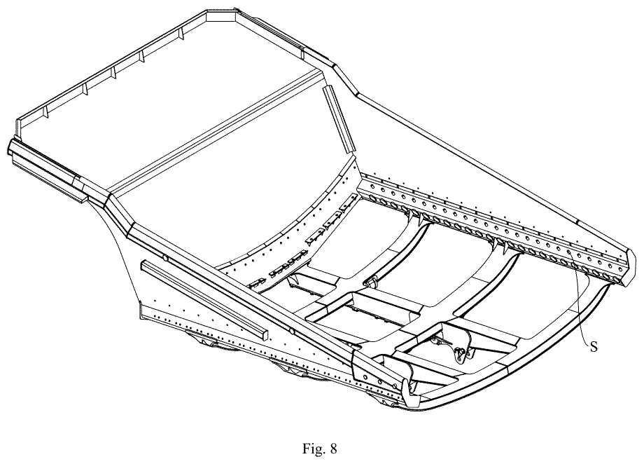

FIG. 7 shows an application example of a second embodiment of the invention wherein the rubber body (1) of the unloading body is arranged to cover or form the floor of a dump truck hopper. In this application, the rubber body (1) is arranged with its outlet end towards the rear of the hopper, that is, where the material or ore exits when the hopper is tilted to an ore unloading position. This means that the thickness gradient increases towards the rear of the hopper avoiding the occurrence of ore stagnation that may occur during the unloading of the hopper (see FIG. 1) and improving the wear resistance of the rubber mat in said rear part of the hopper. It is important to note that the rear part of a dump truck hopper corresponds to the area of the hopper floor through which the greatest amount of ore circulates during unloading, since all the material that is in contact with the floor inside the hopper passes through said area during ore unloading. Furthermore, said rear part of the hopper floor is arranged close to the ground during unloading, making it prone to impact damage. Therefore, the rear part of the hopper floor corresponds to the area with the greatest wear and abrasion damage, as a result of the circulation of ore, and impact, as a result of its proximity to the ground during unloading.

In the dump truck hopper application of FIG. 7 the implementation of a mat with increasing thickness gradient towards the outlet end is apparently counterproductive. Truck hoppers usually have a rear portion inclined upwards, forming a funnel type container that keeps the material or ore inside the hopper when the truck is loading or transporting ore, preventing it from falling out of the hopper accidentally. When the hopper is tilted to unload the ore, said upwardly inclined portion opposes the flow of the ore towards the outlet end, implying that there is a minimum angle of inclination that must be overcome for the material to start moving towards its unloading. As a result of the above, the thickness gradient that includes the rubber mat of the invention is designed seeking to favor the circulation of ore during unloading, generating a transition between a portion of uniform thickness and a portion with a thickness gradient that is not abrupt.

On the other hand, when the rubber mat (1) used in the dump truck hopper of FIG. 7 is arranged to form the floor of said hopper, said rubber mat (1) may appear as a suspended mat that is fixed to a structural frame of the hopper connecting the lateral edges (L) of the rubber mat, shown in FIG. 5, with said structural frame. In this embodiment, which corresponds to the solution proposed in document AU2012327208B2, the rubber mat can also be fixed to the hopper by connecting the front edge of the rubber mat (1) with one or more supports arranged on the front face of the hopper. In addition, the lower face or support face of the rubber mat can be presented suspended on ropes or support bands arranged transversally in the hopper, joining the lateral faces of said hopper by means of said ropes or bands. The ropes or support bands hold the rubber mat in a suspended or hanging manner, providing support, and cushioning to said mat.

Finally, the fixing of the lateral edges (L) of the rubber mat (1) to the structural frame of the hopper can be materialized by means of support pins (S) that are arranged in the structural frame of the hopper, as can be seen in FIG. 8. Said support pins (S) are inserted into holes present in the lateral edge (L) of the rubber mat. Said fixing mechanism or a similar one also applies to the one or more supports that are arranged on the front face of the hopper. Alternatively, both the structural frame and said one or more supports can be presented as perforable plates for fixing the unloading mat by means of screws or bolts.

1. An ore unloading mat formed by a rubber body having a length and a width;
wherein the rubber body comprises an upper face or working face and an outlet end;
wherein the working face corresponds to a zone of the rubber body that is in contact with an ore at least during a circulation of said ore over the rubber body;
wherein the outlet end corresponds to an edge of the rubber body where the circulating ore is no longer in contact with the working face, heading out of the unloading mat;
CHARACTERIZED in that the rubber body has at least two portions, a first portion having a substantially uniform thickness and a second portion having a variable thickness wherein the variable thickness of the second portion generates a thickness gradient that increases towards the outlet end, wherein said thickness gradient is formed by three or more thicknesses distributed in a direction of the ore circulation.

2. The unloading mat of claim 1, CHARACTERIZED in that the rubber body forms a coating wherein the rubber body is fixed to a structural surface that supports the unloading mat.

3. The unloading mat of claim 1, CHARACTERIZED in that the rubber body forms a floor of a dump truck hopper wherein the rubber body is arranged hanging or suspended on a structural frame that forms the hopper.

4. The unloading mat of claim 3, CHARACTERIZED in that the rubber body is fixed to the structural frame by connecting two or more edges of the rubber body with said structural frame, leaving free the edge corresponding to the output end of said rubber body.

5. The unloading mat of claim 3, CHARACTERIZED in that the rubber body comprises a lower face or support face opposite to the working face, wherein said support face is connected to the structural frame by means of a set of ropes or support bands which have two ends that are releasably attached to the structural frame.

6. The unloading mat of claim 5, CHARACTERIZED in that the ropes or support bands are formed by a core wrapped in neoprene.

7. The unloading mat of claim 5, CHARACTERIZED in that the ends of the ropes or support bands are formed by an alloy of materials to improve their resistance, said alloy of materials includes Kevlar or another fiber-reinforced composite material.

8. The unloading mat of claim 5, CHARACTERIZED in that the ends of each rope or support band form an opening that is connected to the structural frame by means of a fixing and tensioning device.

9. The unloading mat of claim 1, CHARACTERIZED in that the thickness gradient presents a continuous variation of the thickness of the rubber body, so that a transition between the first portion of substantially uniform thickness and the second portion of variable thickness is not abrupt.

10. A transfer chute comprising structural walls, an inlet and an outlet, the transfer chute CHARACTERIZED in that it comprises at least one unloading mat according to claim 1, arranged as a covering of at least one of the structural walls, so that the outlet end of the unloading mat is arranged towards the outlet of the chute.

11. A dump truck hopper comprising a rear part, whereby material within the hopper exits the hopper when tilted into an unloading position, the dump truck hopper CHARACTERIZED in that it comprises an unloading mat according to claim 1, arranged so that the outlet end of the unloading mat is arranged towards the rear of the dump truck hopper.

12. The dump truck hopper of claim 11, CHARACTERIZED in that the unloading mat is arranged covering a floor of the dump truck hopper.

13. The dump truck hopper of claim 11, CHARACTERIZED in that the unloading mat is arranged to form a floor of the dump truck hopper, wherein the unloading mat comprises lateral edges and a front edge that are fixed to a structural frame of the dump truck hopper, leaving free the edge corresponding to the outlet end of said rubber body.

14. The dump truck hopper of claim 13, CHARACTERIZED in that the rubber body comprises a lower face or support face opposite to the working face, wherein said support face is connected to the structural frame by means of a set of ropes or support bands having two ends that are releasably attached to the structural frame.

15. The dump truck hopper of claim 14, CHARACTERIZED in that the ropes or support bands are formed by a core wrapped in neoprene, wherein the ends of the ropes or support bands are formed by an alloy of materials to improve their resistance, said alloy of materials includes Kevlar or another material with similar mechanical behavior.

16. The dump truck hopper of claim 13, CHARACTERIZED in that the ends of each rope or support band form an opening that is connected to the structural frame by means of a fixing and tensioning device.
